(19) United States
(12) Patent Application Publication
(10) Pub. No.: US 2025/0097912 A1
(43) Pub. Date: Mar. 20, 2025

(54) METHOD FOR TRANSMITTING SENSING RESULT INFORMATION AND DEVICE

(71) Applicant: GUANGDONG OPPO MOBILE TELECOMMUNICATIONS CORP., LTD., Dongguan (CN)

(72) Inventors: Yanan LIN, Dongguan (CN); Jing XU, Dongguan (CN)

(21) Appl. No.: 18/967,640

(22) Filed: Dec. 3, 2024

Related U.S. Application Data
(63) Continuation of application No. PCT/CN2022/097585, filed on Jun. 8, 2022.

(51) Int. Cl. H04W 72/0446

(52) U.S. Cl. CPC H04W 72/0446

(57) ABSTRACT

Provided is a method for transmitting sensing result information. The method is applicable to a first node, and includes: transmitting M pieces of first sensing result information over a first transmission resource, wherein the M pieces of first sensing result information are acquired based on M sets of sensing signals, and M is a positive integer greater than 1, wherein each set of the M sets of sensing signals comprises at least one sensing signal.

### CROSS-REFERENCE TO RELATED APPLICATION

This application is a continuation of International Application No. PCT/CN2022/097585, filed Jun. 8, 2022, the entire disclosure of which is incorporated herein by reference.

### TECHNICAL FIELD

Embodiments of the present disclosure relates to the technical field of sensing measurement, and in particular, relate to a method and apparatus for transmitting and receiving sensing result information, and a device and a storage medium thereof.

### BACKGROUND

Wireless sensing is a technology for achieving environmental sensing, for example, target positioning, action recognition, and imaging by detecting parameters of a physical environment over backscattered radio waves.

### SUMMARY

Embodiments of the present disclosure provide a method for transmitting sensing result information and a device thereof. The technical solutions are as follows.

According to an aspect of the embodiments of the present disclosure, a method for transmitting sensing result information is provided. The method is applicable to a first node, and includes:
transmitting M pieces of first sensing result information over a first transmission resource,
wherein the M pieces of first sensing result information are acquired based on M sets of sensing signals, and M is a positive integer greater than 1, wherein each set of the M sets of sensing signals includes at least one sensing signal.

According to an aspect of the embodiments of the present disclosure, a method for transmitting sensing result information is provided. The method is applicable to a first node, and includes:
transmitting first information over a second transmission resource upon receiving N sets of sensing signals, wherein N is a positive integer; and
transmitting, in response to receiving schedule information within a first duration, part or all of N pieces of first sensing result information over a third transmission resource scheduled by the schedule information; or, transmitting, in response to a third transmission resource within a first duration, part or all of N pieces of first sensing result information over the third transmission resource;
wherein a start point of the first duration is a transmission position of the first information or is determined based on a transmission position of the first information, the N pieces of first sensing result information are acquired based on the N sets of sensing signals, and each set of the N sets of sensing signals includes at least one sensing signal.

According to an aspect of the embodiments of the present disclosure, a sensing measurement device is provided. The device includes: a processor and a memory storing at least one program, wherein the sensing measurement device, when loading and running the at least one program, is caused to perform the method for transmitting sensing result information.

### BRIEF DESCRIPTION OF DRAWINGS

For clearer descriptions of the technical solutions according to the embodiments of the present disclosure, the following briefly introduces the accompanying drawings required for describing the embodiments. Apparently, the accompanying drawings in the following description show merely some embodiments of the present disclosure, and persons of ordinary skill in the art may still derive other drawings from these accompanying drawings without creative efforts.

FIG. 1 is a schematic diagram of a first sensing scenario according to some embodiments of the present disclosure;

FIG. 2 is a schematic diagram of a second sensing scenario according to some embodiments of the present disclosure;

FIG. 3 is a schematic diagram of a third sensing scenario according to some embodiments of the present disclosure;

FIG. 4 is a schematic diagram of a sensing measurement system according to some embodiments of the present disclosure;

FIG. 5 is a flowchart of a method for transmitting sensing result information according to some embodiments of the present disclosure;

FIG. 6 is a schematic time-frequency diagram of a method for transmitting sensing result information according to some embodiments of the present disclosure;

FIG. 7 is a flowchart of a method for transmitting sensing result information according to some embodiments of the present disclosure;

FIG. 8 is a schematic time-frequency diagram of a method for transmitting sensing result information according to some embodiments of the present disclosure;

FIG. 9 is a schematic time-frequency diagram of a method for transmitting sensing result information according to some embodiments of the present disclosure;

FIG. 10 is a schematic time-frequency diagram of a method for transmitting sensing result information according to some embodiments of the present disclosure;

FIG. 11 is a flowchart of a method for transmitting sensing result information according to some embodiments of the present disclosure;

FIG. 12 is a flowchart of a method for transmitting sensing result information according to some embodiments of the present disclosure;

FIG. 13 is a schematic time-frequency diagram of a method for transmitting sensing result information according to some embodiments of the present disclosure;

FIG. 14 is a flowchart of a method for receiving sensing result information according to some embodiments of the present disclosure;

FIG. 15 is a block diagram of an apparatus for transmitting sensing result information according to some embodiments of the present disclosure;

FIG. 16 is a block diagram of an apparatus for transmitting sensing result information according to some embodiments of the present disclosure;

FIG. 17 is a block diagram of an apparatus for receiving sensing result information according to some embodiments of the present disclosure;

FIG. 18 is a block diagram of an apparatus for receiving sensing result information according to some embodiments of the present disclosure; and

FIG. 19 is a schematic structural diagram of a sensing device according to some embodiments of the present disclosure.

### DETAILED DESCRIPTION

For clearer descriptions of the objectives, technical solutions, and advantages of the present disclosure, embodiments of the present disclosure are described in detail hereinafter in conjunction with the accompanying drawings.

Wireless communication and wireless sensing are two importance applications in the modern radio frequency technology. The wireless sensing achieves environmental sensing, for example, target positioning, action recognition, and imaging by detecting parameters of a physical environment over backscattered radio waves. Traditional wireless sensing and cellular communication are separate from each other, and the separate design causes waste of wireless spectrum and hardware resources.

In the era of beyond 5^{th} generation mobile communication system (B5G) and 6^{th} generation mobile communication system (6G), the communication spectrum is in millimeter wave, terahertz, and visible light communication, and the spectrum of future wireless communication is coincident with traditional sensing spectrum. The communication sensing technology integrates the communication function and the sensing function, and address interference in the traditional wireless sensing using wireless resource management of communication. A wide range of sensing services are achieved using widely deployed cellular networks. Stations and a plurality of terminals are used for joint sensing to achieve higher sensing precision. The hardware module for communication is reused to implement the sensing function, and thus the cost is reduced. In summary, the communication sensing technology enables the future wireless communication system to have the sensing ability, and provides a basis for the future development of smart transportation, smart cities, smart factories, drones and other services.

A plurality of sensing scenarios of station control and terminal assistance are described hereinafter.

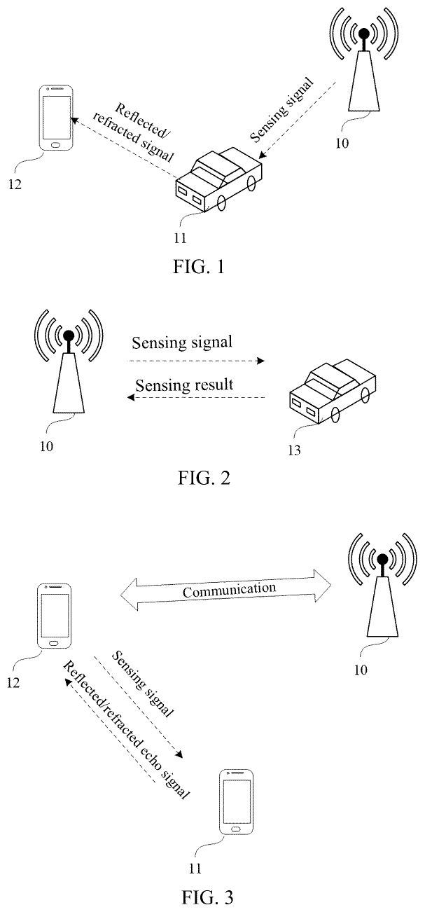

In sensing scenario 1, as shown in FIG. 1, the station 10 transmits a sensing signal to the terminal 11 as a sensing signal transmitter node (STx), the sensing signal is reflected or refracted in the first terminal 11, and the terminal 12 receives the reflected/refracted signal as a sensing signal receiver node to acquire a sensing result and reports the sensing result to the station or other receivers.

In sensing scenario 2, in the case that a sensing object is an active object (for example, a mobile phone, an IoT device, and the like), the sensing performance is improved as the sensing object assistants the sensing to some extent. As shown in FIG. 2, the station 10 transmits a sensing signal to the third terminal 13 as a sensing signal transmitter node. The third terminal 13, as a sensing signal receiver node, acquires a sensing result based on the reflected/refracted signal and reports the sensing result to the station 10 or other receivers (other stations or terminals).

In sensing scenario 3, as shown in FIG. 3, the first terminal 11 transmits a sensing signal to the second terminal 12 as a sensing signal transmitter node, and the first terminal is also determined as a sensing signal receiver node to acquire a sensing result based on reflected/refracted echo signal of the sensing signal, and reports the sensing result to the station 10 or other receivers (other stations or terminals).

The sensing measurement process may also be controlled by one terminal and assisted by other terminals. That is, the station in FIG. 1 to FIG. 3 is replaced by the terminal, which is not described again.

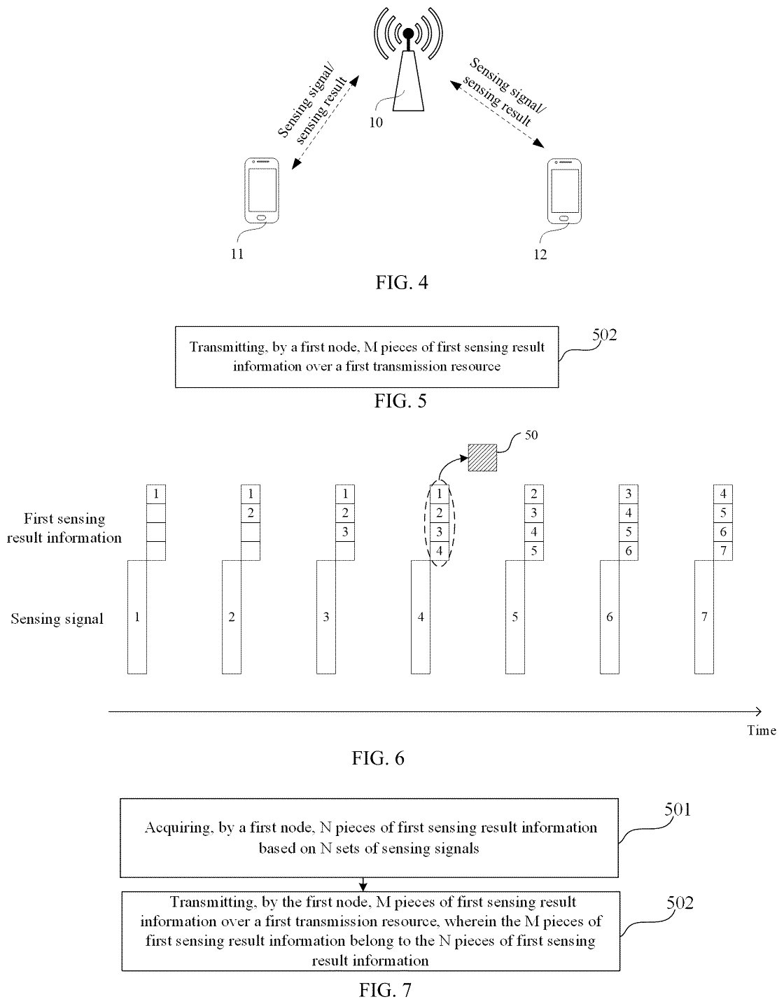

FIG. 4 is a schematic diagram of a sensing measurement system 100 according to some embodiments of the present disclosure. The sensing measurement system 100 includes a station 10, a first terminal 11, and a second terminal 12.

The station 10 is also referred to as an access network device, and is configured to control usage of air interface resources by the first terminal 11 and the second terminal 12.

In some sensing scenarios, the first terminal 11 is a first node, and the first node serves as a sensing signal receiver node. The station 10 is a second node, and the second node serves as a sensing signal transmitter node, a sensing result receiver node, and a sensing controller node.

In some sensing scenarios, the first terminal 11 is a first node, and the first node serves as a sensing signal receiver node. The second terminal 12 is a second node, and the second node serves as a sensing signal transmitter node and a sensing result receiver node. The station 10 is a sensing controller node.

Various devices play different sensing measurement roles, which are not enumerated one by one in the embodiments.

In the case that a terminal assists in sensing as a sensing signal receiver node, the terminal caches a plurality of pieces of sensing result information upon receiving a plurality of sets of sensing signals. In this case, how to transmit a plurality of pieces of sensing result information to a sensing control node or a sensing result transmitter node is a technical problem that has not been solved currently.

FIG. 5 is a flowchart of a method for transmitting sensing result information according to some embodiments of the present disclosure. The embodiments are illustrated using the method being applicable to a first node as an example. The method includes following processes.

In S502, a first node transmits M pieces of first sensing result information over a first transmission resource.

The first node is a node participating in the sensing measurement. In some embodiments, the first node transmits M pieces of first sensing result information to a second node over the first transmission resource. The second node functions as a sensing signal transmitter node or a sensing controller node.

The first node is a sensing signal receiver node. In some embodiments, the first node functions as both a sensing signal transmitter node and a sensing signal receiver node. Roles of the first node in a sensing measurement process are not limited in the embodiments, which are determined according to actual sensing scenarios.

The M pieces of first sensing result information are acquired based on M sets of sensing signals, and M is a positive integer greater than 1. Each set of the M sets of sensing signals includes at least one sensing signal, and numbers of sensing signals in various sets of sensing signals are the same or different.

In some embodiments, time domain positions of transmitting the M sets of sensing signals are different, or, time domain positions of transmitting at least two sets of sensing signals are different. In some embodiments, the M sets of sensing signals are transmitted periodically or nonperiodically. In some embodiments, the M sets of sensing signals are continuous M sets of sensing signals in a plurality of periodically transmitted sets of sensing signals, or, the M sets of sensing signals are M sets of sensing signals specific or screened out (may be discontinuous) in a plurality of periodically transmitted sets of sensing signals.

Illustratively, as shown in FIG. 6, the first node transmits four pieces of first sensing result information 1 to 4 over a first transmission resource 50. The first sensing result information 1 is acquired based on a first set of sensing signals, the first sensing result information 2 is acquired based on a second set of sensing signals, the first sensing result information 3 is acquired based on a third set of sensing signals, and the first sensing result information 4 is acquired based on a fourth set of sensing signals.

The first transmission resource is a periodic transmission resource, a semi-statically indicated transmission resource, or a dynamically indicated transmission resource. The first transmission resource is configured by a second node for the first node, configured by a sensing controller node for the first node, or is autonomously selected by the first node in a resource pool.

In some embodiments, the M sets of sensing signals are last M sets of sensing signals prior to a first time position.

### The First Time Position

In some embodiments, the first time position is in one of following cases.

The first time position is a time domain position of the first transmission resource.

The first time position is a start position of the first transmission resource in a time domain, or, the first time position is an end position of the first transmission resource in a time domain.

The first time position is determined based on a time domain position of the first transmission resource.

The first time position is determined based on a start position of the first transmission resource in a time domain, the first time position is determined based on an end position of the first transmission resource in a time domain, or, the first time position is determined based on a start position and an end position of the first transmission resource in a time domain, for example, a middle position of the start position and the end position.

Illustratively, the first time position is a time position T duration in advance of the time domain position of the first transmission resource. The T duration is predefined, preconfigured, or autonomously determined. The T duration is correlated with a processing delay of the first node in generating sensing result information based on the sensing signal.

The first time position is a transmission position of indication information.

The indication information instructs the first node to transmit the M pieces of first sensing result information. The indication information is transmitted from the second node to the first node, or, the indication information is transmitted from a sensing controller node different from the second node to the first node.

The first time position is determined based on a transmission position of indication information.

The first time position is determined based on a start position of the transmission position of the indication information in a time domain, the first time position is determined based on an end position of the transmission position of the indication information in a time domain, or, the first time position is determined based on a start position and an end position of the transmission position of the indication information in a time domain, for example, a middle position of the start position and the end position.

Illustratively, the first time position is a time position T duration in advance of the transmission position of the indication information. The T duration is predefined, preconfigured, or autonomously determined. The T duration is correlated with a processing delay of the first node in generating sensing result information based on the sensing signal.

### The First Sensing Result Information

In some embodiments, the first sensing result information includes at least one of following pieces of information.

Characteristic parameters of the sensing signals.

The characteristic parameters of the M sets of sensing signals include a signal amplitude, a signal amplitude mean, a signal amplitude variance, an angle difference, an angle mean, an angle variance, mean/variance distribution of the amplitude, mean/variance distribution of the angle, a power spectrum, doppler shift information, and the like.

Offset information or difference information of characteristic parameters of the sensing signals.

The offset information of the characteristic parameters indicates offsets of characteristic parameters of a current sensing signal relative to characteristic parameters of a reference sensing signal, and the difference information of the characteristic parameters indicates difference information of characteristic parameters of a current sensing signal relative to characteristic parameters of a reference sensing signal. The offset information and the difference information are the same information or the same type of information.

The reference sensing signal is a first sensing signal, a first sensing signal within a duration, a first sensing signal in a period, a first sensing signal in a same set of sensing signals, a previous sensing signal of a current sensing signal, or a first sensing signal in currently reported M sensing signals, and a method for selecting the reference sensing signal is not limited in the embodiments.

Channel information experienced by the sensing signals.

The channel information experienced by the sensing signals includes at least one of channel matrix information, a multi-path delay, or fading information.

Offset information or difference information of channel information experienced by the M sensing signals.

The offset information of channel information indicates offsets of channel information of a current sensing signal relative to channel information of a reference sensing signal, and the difference information of the channel information indicates difference information of channel information of a current sensing signal relative to channel information of a reference sensing signal. The offset information and the difference information are the same information or the same type of information.

The reference sensing signal is a first sensing signal, a first sensing signal within a duration, a first sensing signal in a period, a first sensing signal in a same set of sensing signals, a previous sensing signal of a current sensing signal, or a first sensing signal in currently reported M sensing signals, and a method for selecting the reference sensing signal is not limited in the embodiments.

An application-oriented sensing result.

For example, the sensing result is applicable to scenarios of falling of a person or object, intrusion of a moving object, counting of target objects, and the like.

In summary, in the method according to the embodiments, in the case that the first node senses a plurality of pieces of first sensing result information, fewer pieces of first transmission resources are used to transmit the M pieces of first sensing result information simultaneously by standardizing the reporting mode of the first node, without reporting the first sensing result information piece by piece, such that the resource consumption required in the process of reporting the sensing results is saved, and the signaling overhead is reduced.

FIG. 7 is a flowchart of a method for transmitting sensing result information according to some embodiments of the present disclosure. The embodiments are illustrated using the method being applicable to a first node as an example. The method includes following processes.

In S501, a first node acquires N pieces of first sensing result information based on N sets of sensing signals.

N is greater than N, and the N pieces of first sensing result information include M pieces of first sensing result information.

The first node is a node participating in the sensing measurement. In some embodiments, the first node is a sensing signal receiver node. In some embodiments, the first node is both a sensing signal transmitter node and a sensing signal receiver node. Roles of the first node in a sensing measurement process are not limited in the embodiments, which are determined according to actual sensing scenarios.

In some embodiments, time domain positions of transmitting the N sets of sensing signals are different, or, time domain positions of transmitting at least two sets of sensing signals are different. In some embodiments, the N sets of sensing signals are transmitted periodically or nonperiodically.

In some embodiments, a sensing transmitter node transmits a plurality of sets of sensing signals. The first node acquires N pieces of first sensing result information based on N sets of sensing signals. That is, the N pieces of first sensing result information are acquired based on N sets of sensing signals. N is a positive integer greater than 1, each set of the N sets of sensing signals includes at least one sensing signal, and numbers of sensing signals in various sets of sensing signals are the same or different. In some embodiments, N is correlated to a caching capability of the first node. For example, N is equal to or less than the number of pieces of first sensing result information that are cacheable by the first node.

In some embodiments, the N sets of sensing signals are last N sets of sensing signals prior to a second time position. For example, N is equal to 4, and the N sets of sensing signals are last four sets of sensing signals prior to the second time position. The N pieces of first sensing result information are last four pieces of first sensing result information prior to the second time position. In some embodiments, in a start stage or an ending stage of a plurality of sets of sensing signals, the first sensing result information acquired prior to the second time position by the first node is less than the N pieces of first sensing result information.

### The Second Time Position

In some embodiments, the second time position is in one of following cases.

The second time position is a time domain position of the first transmission resource.

The second time position is a start position of the first transmission resource in a time domain, or, the second time position is an end position of the first transmission resource in a time domain.

The second time position is determined based on a time domain position of the first transmission resource.

The second time position is determined based on a start position of the first transmission resource in a time domain, the second time position is determined based on an end position of the first transmission resource in a time domain, or, the second time position is determined based on a start position and an end position of the first transmission resource in a time domain, for example, a middle position of the start position and the end position.

Illustratively, the second time position is a time position T duration in advance of the time domain position of the first transmission resource. The T duration is predefined, preconfigured, or autonomously determined. The T duration is correlated with a processing delay of the first node in generating sensing result information based on the sensing signal.

The second time position is a transmission position of indication information.

The second time position instructs the first node to transmit the M pieces of first sensing result information. The indication information is transmitted from the second node to the first node, or, the indication information is transmitted from a sensing controller node different from the second node to the first node.

The second time position is determined based on a transmission position of indication information.

The second time position is determined based on a start position of the transmission position of the indication information in a time domain, the second time position is determined based on an end position of the transmission position of the indication information in a time domain, or, the second time position is determined based on a start position and an end position of the transmission position of the indication information in a time domain, for example, a middle position of the start position and the end position.

Illustratively, the second time position is a time position T duration in advance of the transmission position of the indication information. The T duration is predefined, preconfigured, or autonomously determined. The T duration is correlated with a processing delay of the first node in generating sensing result information based on the sensing signal.

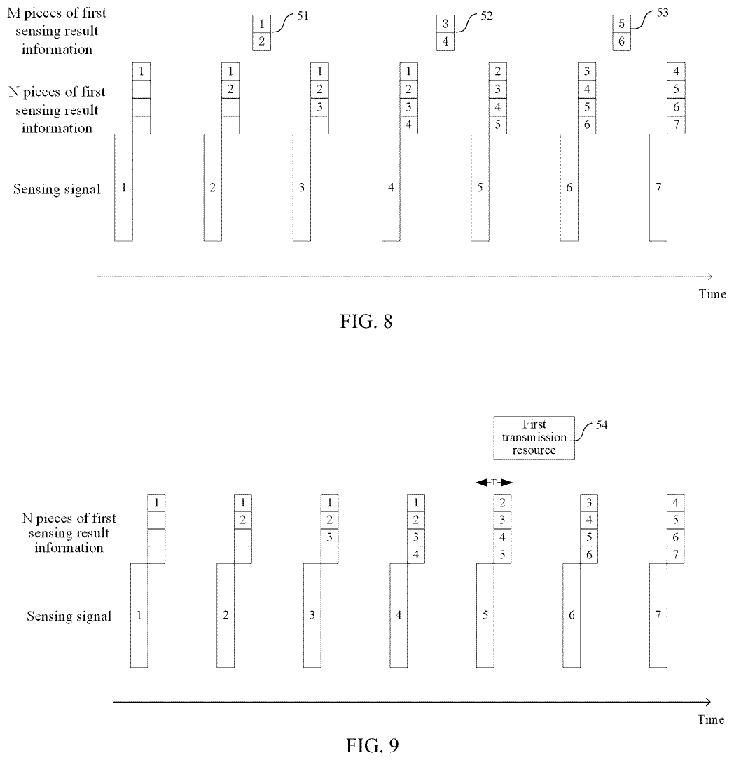

Illustratively, as shown in FIG. 8, assuming that N is equal to 4, and then the second time position is a start position of the first transmission resource in the time domain. The first node caches last four pieces of first sensing result information. Prior to the second time position 51, four sets of sensing result information only include first sensing result information 1 and first sensing result information 2. Prior to the second time position 52, four sets of sensing result information include first sensing result information 1 to 4. Prior to the second time position 53, four sets of sensing result information include first sensing result information 3 to 6.

Illustratively, as shown in FIG. 9, assuming that N is equal to 4, the second time position is a time position T duration in advance of a time domain position of the first transmission resource. Prior to the second time position 54, four sets of sensing result information include first sensing result information 1 to 4.

In some embodiments, transmission resources of the plurality of sets or N sets of sensing information are semi-statically configured periodic resources, or transmission resources of each set of the plurality of sets or N sets of sensing signals are dynamic resources that are dynamically configured. A method for transmitting the plurality of sets or N sets of sensing information is not limited in the embodiments.

### The First Sensing Result Information

In some embodiments, the first sensing result information includes at least one of following pieces of information.

Characteristic parameters of the sensing signals.

The characteristic parameters of the M sets of sensing signals include a signal amplitude, a signal amplitude mean, a signal amplitude variance, an angle difference, an angle mean, an angle variance, mean/variance distribution of the amplitude, mean/variance distribution of the angle, a power spectrum, doppler shift information, and the like.

Offset information or difference information of characteristic parameters of the sensing signals.

The offset information of the characteristic parameters indicates offsets of characteristic parameters of a current sensing signal relative to characteristic parameters of a reference sensing signal, and the difference information of the characteristic parameters indicates difference information of characteristic parameters of a current sensing signal relative to characteristic parameters of a reference sensing signal. The offset information and the difference information are the same information or the same type of information.

The reference sensing signal is a first sensing signal, a first sensing signal within a duration, a first sensing signal in a period, a first sensing signal in a same set of sensing signals, a previous sensing signal of a current sensing signal, or a first sensing signal in currently reported M sensing signals, and a method for selecting the reference sensing signal is not limited in the embodiments.

Channel information experienced by the sensing signals.

The channel information experienced by the sensing signals includes at least one of channel matrix information, a multi-path delay, or fading information.

Offset information or difference information of channel information experienced by the M sensing signals.

The offset information of channel information indicates offsets of channel information of a current sensing signal relative to channel information of a reference sensing signal, and the difference information of the channel information indicates difference information of channel information of a current sensing signal relative to channel information of a reference sensing signal. The offset information and the difference information are the same information or the same type of information.

The reference sensing signal is a first sensing signal, a first sensing signal within a duration, a first sensing signal in a period, a first sensing signal in a same set of sensing signals, a previous sensing signal of a current sensing signal, or a first sensing signal in currently reported M sensing signals, and a method for selecting the reference sensing signal is not limited in the embodiments.

An application-oriented sensing result.

For example, the sensing result is applicable to scenarios of falling of a person or object, intrusion of a moving object, counting of target objects, and the like.

In S502, the first node transmits M pieces of first sensing result information over a first transmission resource.

The M pieces of first sensing result information are acquired based on M sets of sensing signals, and M is a positive integer greater than 1. Each set of the M sets of sensing signals includes at least one sensing signal.

In some embodiments, time domain positions of transmitting the M sets of sensing signals are different, or, time domain positions of transmitting at least two sets of sensing signals are different. In some embodiments, the M sets of sensing signals are transmitted periodically or nonperiodically. In some embodiments, the M sets of sensing signals are continuous M sets of sensing signals in a plurality of periodically transmitted sets of sensing signals, or, the M sets of sensing signals are M sets of sensing signals specified or screened out (may be discontinuous) in a plurality of periodically transmitted sets of sensing signals.

The first transmission resource is a periodic transmission resource, a semi-statically indicated transmission resource, or a dynamically indicated transmission resource. The first transmission resource is configured by a second node for the first node, configured by a sensing controller node for the first node, or is autonomously selected by the first node in a resource pool.

In some embodiments, the first node receives indication information. The indication information instructs the first node to transmit the M pieces of first sensing result information. In some embodiments, the indication information is indicative of a value of M. Alternatively, the indication information is indicative of the M pieces of first sensing result information. That is, M pieces of first sensing result information are acquired from N pieces of first sensing result information, for example, bitmaps.

In some embodiments, the first node receives configuration information, and the configuration information is indicative of information indicating at least one of: the first transmission resource, or a value of M. The configuration information and the above indication information are the same information or different information. For example, in the case that the first transmission resource is a dynamically indicated transmission resource, the configuration information and the indication information are the same information. For example, in the case that the first transmission resource is a semi-statically indicated periodic transmission resource, the configuration information and the indication information are different information, the configuration information is a semi-statically configured configuration information, and the indication information a semi-statically configured activation signaling.

In some embodiments, the M sets of sensing signals are last M sets of sensing signals prior to the first time position.

### The First Time Position

In some embodiments, the first time position is in one of following cases.

The first time position is a time domain position of the first transmission resource.

The first time position is a start position of the first transmission resource in a time domain, or, the first time position is an end position of the first transmission resource in a time domain.

The first time position is determined based on a time domain position of the first transmission resource.

The first time position is determined based on a start position of the first transmission resource in a time domain, the first time position is determined based on an end position of the first transmission resource in a time domain, or, the first time position is determined based on a start position and an end position of the first transmission resource in a time domain, for example, a middle position of the start position and the end position.

Illustratively, the first time position is a time position T duration in advance of the time domain position of the first transmission resource. The T duration is predefined, preconfigured, or autonomously determined. The T duration is correlated with a processing delay of the first node in generating sensing result information based on the sensing signal.

The first time position is a transmission position of indication information.

The indication information instructs the first node to transmit the M pieces of first sensing result information. The indication information is transmitted from the second node to the first node, or, the indication information is transmitted from a sensing controller node different from the second node to the first node.

The first time position is determined based on a transmission position of indication information.

The first time position is determined based on a start position of the transmission position of the indication information in a time domain, the first time position is determined based on an end position of the transmission position of the indication information in a time domain, or, the first time position is determined based on a start position and an end position of the transmission position of the indication information in a time domain, for example, a middle position of the start position and the end position.

Illustratively, the first time position is a time position T duration in advance of the transmission position of the indication information. The T duration is predefined, preconfigured, or autonomously determined. The T duration is correlated with a processing delay of the first node in generating sensing result information based on the sensing signal.

In some embodiments, the first time position and the second time position are a same time position or different time positions. For example, the second time position is determined based on a time domain position of the first transmission resource, and the first time position is determined based on a transmission position of the indication information.

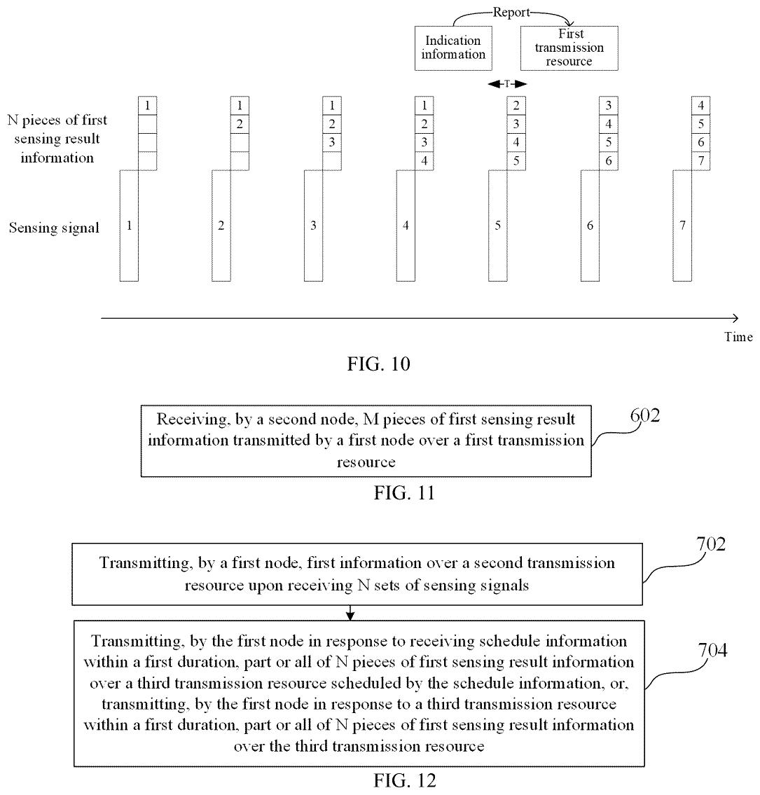

Illustratively, referring to FIG. 10, assuming that the first time position and the second time position are the same and are the transmission position of the first transmission resource, M is equal to 2, and then the M pieces of first sensing result information include first sensing result information 4 and first sensing result information 5. Assuming that the second time position is a transmission position of the indication information, the transmission position of the first transmission resource is a position of T duration in advance of the first transmission resource, M is equal to 2, and then the M pieces of first sensing result information include first sensing result information 3 and first sensing result information 4.

In some embodiments, the M pieces of first sensing result information are acquired from the N pieces of first sensing result information based on the indication information. Illustratively, the indication information carries a bitmap.

For example, the N pieces of first sensing result information are first sensing result information 1 to 4, the M pieces of first sensing result information are first sensing result information 1 and first sensing result information 3 in the case that the bitmap is equal to 1010, and the M pieces of first sensing result information are first sensing result information 3 and first sensing result information 4 in the case that the bitmap is equal to 0011. That is, the bitmap includes N bits, i^{th} first sensing result information belongs to the M pieces of first sensing result information in the case that a value of an i^{th} bit is a first value (for example, 1), and i^{th} first sensing result information does not belong to the M pieces of first sensing result information in the case that a value of the i^{th} bit is a second value (for example, 0).

In summary, in the method according to the embodiments, in the case that the first node senses a plurality of pieces of first sensing result information, fewer pieces of first transmission resources are used to transmit the M pieces of first sensing result information simultaneously by standardizing the reporting mode of the first node, without reporting each first sensing result information piece by piece, such that the resource consumption required in the process of reporting the sensing results is saved, and the signaling overhead is reduced.

In the method according to the embodiments, in the case that N is greater than M, the sensing controller node triggers, based on sensing requirements, the first node to report much first sensing result information (that is, a value of M is increased to a maximum of N), such that sensing precision is improved; and in the case that N is equal to M, storage resource requirements of the first node are reduced, and hardware cost or storage overhead of the first node is reduced.

In the method according to the embodiments, the second node or the sensing controller node indicates M pieces of first sensing result information required to be reported for the first node by the bitmap. The first node stores a plurality of latest first sensing result information, and the second node or the sensing controller node requires the first node to report a plurality of specific sensing results based on performance requirements of a sensing service to detect changes of the sensing signals, such that a more accurate sensing result is acquired.

FIG. 7 is a flowchart of a method for receiving sensing result information according to some embodiments of the present disclosure. The embodiments are illustrated using the method being applicable to a second node as an example. The method includes following processes.

In S602, a second node receives M pieces of first sensing result information transmitted by a first node over a first transmission resource.

The second node is a node participating in the sensing measurement. In some embodiments, the second node is a sensing signal transmitter node or a sensing controller node.

The first node is a node participating in the sensing measurement. In some embodiments, the first node transmits M pieces of first sensing result information to a second node over the first transmission resource. The second node is a sensing signal transmitter node, a sensing controller node, or both a sensing signal transmitter node and a sensing controller node. Roles of the second node in a sensing measurement process are not limited in the embodiments, which are determined according to actual sensing scenarios.

The first node is a sensing signal receiver node. In some embodiments, the first node is both a sensing signal transmitter node and a sensing signal receiver node. Roles of the first node in a sensing measurement process are not limited in the embodiments, which are determined according to actual sensing scenarios.

The M pieces of first sensing result information are acquired based on M sets of sensing signals, and M is a positive integer greater than 1. Each set of the M sets of sensing signals includes at least one sensing signal, and numbers of sensing signals in various sets of sensing signals are the same or different.

In some embodiments, time domain positions of transmitting the M sets of sensing signals are different, or, time domain positions of transmitting at least two sets of sensing signals are different. In some embodiments, the M sets of sensing signals are transmitted periodically or nonperiodically. In some embodiments, the M sets of sensing signals are continuous M sets of sensing signals in a plurality of periodically transmitted sets of sensing signals, or, the M sets of sensing signals are M sets of sensing signals specified or screened out (may be discontinuous) in a plurality of periodically transmitted sets of sensing signals.

The first transmission resource is a periodic transmission resource, a semi-statically indicated transmission resource, or a dynamically indicated transmission resource. The first transmission resource is configured by a second node for the first node, configured by a sensing controller node for the first node, or is autonomously selected by the first node in a resource pool.

In some embodiments, the M sets of sensing signals are last M sets of sensing signals prior to a first time position.

### The First Time Position

In some embodiments, the first time position is in one of following cases.

The first time position is a time domain position of the first transmission resource.

The first time position is a start position of the first transmission resource in a time domain, or, the first time position is an end position of the first transmission resource in a time domain.

The first time position is determined based on a time domain position of the first transmission resource.

The first time position is determined based on a start position of the first transmission resource in a time domain, the first time position is determined based on an end position of the first transmission resource in a time domain, or, the first time position is determined based on a start position and an end position of the first transmission resource in a time domain, for example, a middle position of the start position and the end position.

Illustratively, the first time position is a time position T duration in advance of the time domain position of the first transmission resource. The T duration is predefined, preconfigured, or autonomously determined. The T duration is correlated with a processing delay of the first node in generating sensing result information based on the sensing signal.

The first time position is a transmission position of indication information.

The indication information instructs the first node to transmit the M pieces of first sensing result information. The indication information is transmitted from the second node to the first node, or, the indication information is transmitted from a sensing controller node different from the second node to the first node.

The first time position is determined based on a transmission position of indication information.

The first time position is determined based on a start position of the transmission position of the indication information in a time domain, the first time position is determined based on an end position of the transmission position of the indication information in a time domain, or, the first time position is determined based on a start position and an end position of the transmission position of the indication information in a time domain, for example, a middle position of the start position and the end position.

Illustratively, the first time position is a time position T duration in advance of the transmission position of the indication information. The T duration is predefined, preconfigured, or autonomously determined. The T duration is correlated with a processing delay of the first node in generating sensing result information based on the sensing signal.

### The First Sensing Result Information

In some embodiments, the first sensing result information includes at least one of following pieces of information.

Characteristic parameters of the sensing signals.

The characteristic parameters of the M sets of sensing signals include a signal amplitude, a signal amplitude mean, a signal amplitude variance, an angle difference, an angle mean, an angle variance, mean/variance distribution of the amplitude, mean/variance distribution of the angle, a power spectrum, doppler shift information, and the like.

Offset information or difference information of characteristic parameters of the sensing signals.

The offset information of the characteristic parameters indicates offsets of characteristic parameters of a current sensing signal relative to characteristic parameters of a reference sensing signal, and the difference information of the characteristic parameters indicates difference information of characteristic parameters of a current sensing signal relative to characteristic parameters of a reference sensing signal. The offset information and the difference information are the same information or the same type of information.

The reference sensing signal is a first sensing signal, a first sensing signal within a duration, a first sensing signal in a period, a first sensing signal in a same set of sensing signals, a previous sensing signal of a current sensing signal, or a first sensing signal in currently reported M sensing signals, and a method for selecting the reference sensing signal is not limited in the embodiments.

Channel information experienced by the sensing signals.

The channel information experienced by the sensing signals includes at least one of channel matrix information, a multi-path delay, or fading information.

Offset information or difference information of channel information experienced by the M sensing signals.

The offset information of channel information indicates offsets of channel information of a current sensing signal relative to channel information of a reference sensing signal, and the difference information of the channel information indicates difference information of channel information of a current sensing signal relative to channel information of a reference sensing signal. The offset information and the difference information are the same information or the same type of information.

The reference sensing signal is a first sensing signal, a first sensing signal within a duration, a first sensing signal in a period, a first sensing signal in a same set of sensing signals, a previous sensing signal of a current sensing signal, or a first sensing signal in currently reported M sensing signals, and a method for selecting the reference sensing signal is not limited in the embodiments.

An application-oriented sensing result.

For example, the sensing result is applicable to scenarios of falling of a person or object, intrusion of a moving object, counting of target objects, and the like.

In the case that the second node is a sensing signal transmitter node, the second node transmits a plurality of sets of sensing signals to the first node in advance. Illustratively, the second node transmits N sets of sensing signals to the first node. The N pieces of first sensing result information are acquired based on the N sets of sensing signals. N is a positive integer greater than 1, and each set of the N sets of sensing signals includes at least one sensing signal.

In some embodiments, time domain positions of transmitting the N sets of sensing signals are different, or, time domain positions of transmitting at least two sets of sensing signals are different. In some embodiments, the N sets of sensing signals are transmitted periodically or nonperiodically.

In some embodiments, N is correlated to a caching capability of the first node. For example, N is equal to or less than the number of pieces of first sensing result information that are cacheable by the first node.

In some embodiments, the N sets of sensing signals are last N sets of sensing signals prior to a second time position. For example, N is equal to 4, and the N sets of sensing signals are last four sets of sensing signals prior to the second time position. The N pieces of first sensing result information are last four pieces of first sensing result information prior to the second time position. In some embodiments, in a start stage or an ending stage of a plurality of sets of sensing signals, the first sensing result information acquired prior to the second time position by the first node is less than the N pieces of first sensing result information.

### The Second Time Position

In some embodiments, the second time position is in one of following cases.

The second time position is a time domain position of the first transmission resource.

The second time position is a start position of the first transmission resource in a time domain, or, the second time position is an end position of the first transmission resource in a time domain.

The second time position is determined based on a time domain position of the first transmission resource.

The second time position is determined based on a start position of the first transmission resource in a time domain, the second time position is determined based on an end position of the first transmission resource in a time domain, or, the second time position is determined based on a start position and an end position of the first transmission resource in a time domain, for example, a middle position of the start position and the end position.

Illustratively, the second time position is a time position T duration in advance of the time domain position of the first transmission resource. The T duration is predefined, preconfigured, or autonomously determined. The T duration is correlated with a processing delay of the first node in generating sensing result information based on the sensing signal.

The second time position is a transmission position of indication information.

The second time position instructs the first node to transmit the M pieces of first sensing result information. The indication information is transmitted from the second node to the first node, or, the indication information is transmitted from a sensing controller node different from the second node to the first node.

The second time position is determined based on a transmission position of indication information.

The second time position is determined based on a start position of the transmission position of the indication information in a time domain, the second time position is determined based on an end position of the transmission position of the indication information in a time domain, or, the second time position is determined based on a start position and an end position of the transmission position of the indication information in a time domain, for example, a middle position of the start position and the end position.

Illustratively, the second time position is a time position T duration in advance of the transmission position of the indication information. The T duration is predefined, preconfigured, or autonomously determined. The T duration is correlated with a processing delay of the first node in generating sensing result information based on the sensing signal.

In some embodiments, transmission resources of the plurality of sets or N sets of sensing information are semi-statically configured periodic resources, or transmission resources of each set of the plurality of sets or N sets of sensing signals are dynamic resources that are dynamically configured. A method for transmitting the plurality of sets or N sets of sensing information is not limited in the embodiments.

In some embodiments, the second node transmits indication information to the first node. The indication information instructs the first node to transmit the M pieces of first sensing result information. In some embodiments, the indication information is indicative of a value of M. Alternatively, the indication information is indicative of the M pieces of first sensing result information. That is, M pieces of first sensing result information are acquired from N pieces of first sensing result information, for example, bitmaps.

The bitmap instructs the first node to determine the M pieces of first sensing result information from N pieces of first sensing result information.

For example, the N pieces of first sensing result information are first sensing result information 1 to 4, the M pieces of first sensing result information are first sensing result information 1 and first sensing result information 3 in the case that the bitmap is equal to 1010, and the M pieces of first sensing result information are first sensing result information 3 and first sensing result information 4 in the case that the bitmap is equal to 0011. That is, the bitmap includes N bits, i^{th} first sensing result information belongs to the M pieces of first sensing result information in the case that a value of an i^{th} bit is a first value (for example, 1), and i^{th} first sensing result information does not belong to the M pieces of first sensing result information in the case that a value of the i^{th} bit is a second value (for example, 0).

In summary, in the method according to the embodiments, in the case that the first node senses a plurality of pieces of first sensing result information, fewer pieces of first transmission resources are used to transmit the M pieces of first sensing result information simultaneously by standardizing the reporting mode of the first node, without reporting each first sensing result information piece by piece, such that the resource consumption required in the process of reporting the sensing results is saved, and the signaling overhead is reduced.

In the method according to the embodiments, in the case that N is greater than M, the sensing controller node triggers, based on sensing requirements, the first node to report much first sensing result information (that is, a value of M is increased to a maximum of N), such that sensing precision is improved; and in the case that N is equal to M, storage resource requirements of the first node are reduced, and hardware cost or storage overhead of the first node is reduced.

In the method according to the embodiments, the second node or the sensing controller node indicates M pieces of first sensing result information required to be reported for the first node by the bitmap. The first node stores a plurality of pieces of latest first sensing result information, and the second node or the sensing controller node requires the first node to report a plurality of specific sensing results based on performance requirements of a sensing service to detect changes of the sensing signals, such that a more accurate sensing result is acquired.

FIG. 12 is a flowchart of a method for transmitting sensing result information according to some embodiments of the present disclosure. The embodiments are illustrated using the method being applicable to a first node as an example. The method includes following processes.

In S702, a first node transmits first information over a second transmission resource upon receiving N sets of sensing signals, wherein N is a positive integer.

The first node is a node participating in the sensing measurement. In some embodiments, the first node is a sensing signal receiver node. In some embodiments, the first node is a sensing signal transmitter node or a sensing signal receiver node. Roles of the second node in a sensing measurement process are not limited in the embodiments, which are determined according to actual sensing scenarios.

The first node receives N sets of sensing signals, and generates N pieces of first sensing result information based on the N sets of sensing signals. Each set of the N sets of sensing signals includes at least one sensing signal, and numbers of sensing signals in various sets of sensing signals are the same or different. The N pieces of first sensing result information are acquired based on N sets of sensing signals, and N is a positive integer greater than 1. Each set of the N sets of sensing signals includes at least one sensing signal.

In some embodiments, time domain positions of transmitting the N sets of sensing signals are different, or, time domain positions of transmitting at least two sets of sensing signals are different. In some embodiments, the N sets of sensing signals are transmitted periodically or nonperiodically.

In some embodiments, a sensing transmitter node transmits a plurality of sets of sensing signals. The first node acquires N pieces of first sensing result information based on N sets of sensing signals. In some embodiments, N is correlated to a caching capability of the first node. For example, N is equal to or less than the number of pieces of first sensing result information that are cacheable by the first node.

In some embodiments, the first information is indicative of all or part of first sensing result information that the first node expects to report. In some embodiments, the first information is indicative of abnormal first sensing result information. In some embodiments, the first information is for requesting to schedule transmission resources of all or part of the N pieces of first sensing result information.

In some embodiments, the first information includes information indicating at least one of:
an application-oriented sensing result, and the application-oriented sensing result is determined based on the N sets of sensing signals;
resource request information, wherein the resource request information is for requesting the third transmission resource; or
information acquired based on at least one of the N pieces of first sensing result information.

In some embodiments, the application-oriented sensing result is abnormal sensing result information, for example, falling of a person or object, intrusion of a moving object, counting of target objects, and the like.

In some embodiments, the resource request information is for requesting the second node or the sensing controller node to schedule the third transmission resource. The third transmission resource is for the first node to transmit part or all of the N pieces of first sensing result information. The resource request information is a scheduling request (SR).

In some embodiments, the information acquired (screened out) based on at least one of the N pieces of first sensing result information is abnormal sensing result information. Illustratively, the abnormal sensing result information includes sensing result information in the N pieces of first sensing result information that has a value less than a first threshold, sensing result information in the N pieces of first sensing result information that has a value greater than a second threshold, or sensing result information in the N pieces of first sensing result information that has a value change reaching a hopping condition.

The first threshold, the second threshold, and the hopping condition are predefined, preconfigured, dynamically configured, or dynamically determined based on the N pieces of first sensing result information. For example, the first threshold, the second threshold, and the hopping condition are determined based on a mean value and a variance of the N pieces of first sensing result information.

In some embodiments, the first information is further indicative of a value of N or a data amount of the N pieces of first sensing result information.

The second transmission resource is transmission resource occupied by the first information. In some embodiments, the second transmission resource is preconfigured by the second node or the sensing controller node, the second transmission resource is acquired by requesting to the second node or the sensing controller node by the first node through the SR, or the second transmission resource is acquired by self-selecting from a preconfigured resource pool by the first node. The configuration information of the second transmission resource is not limited in the embodiments.

In some embodiments, the N sets of sensing signals are last N sets of sensing signals prior to a third time position. For example, N is equal to 4, and the N sets of sensing signals are last four sets of sensing signals prior to the third time position. The N pieces of first sensing result information are last four pieces of first sensing result information prior to the third time position. In some embodiments, in a start stage or an ending stage of a plurality of sets of sensing signals, the first sensing result information acquired prior to the third time position by the first node is less than the N pieces of first sensing result information.

### The Third Time Position

In some embodiments, the third time position is in one of following cases.

The third time position is a transmission position (that is, the second transmission resource) of the first information.

The third time position is a start position of the second transmission resource in a time domain, or, the third time position is an end position of the second transmission resource in a time domain.

The third time position is determined based on a time domain position of a transmission position of the first information.

The third time position is determined based on a start position of the second transmission resource in a time domain, the third time position is determined based on an end position of the second transmission resource in a time domain, or, the third time position is determined based on a start position and an end position of the second transmission resource in a time domain, for example, a middle position of the start position and the end position.

Illustratively, the third time position is a time position T duration in advance of the time domain position of the second transmission resource. The T duration is predefined, preconfigured, or autonomously determined. The T duration is correlated with a processing delay of the first node in generating sensing result information based on the sensing signal.

The third time position is a transmission position of resource configuration information of the second transmission resource.

The resource configuration information of the second transmission resource is for configuring the second transmission resource. The resource configuration information of the second transmission resource is transmitted from the second node to the first node, or, the resource configuration information of the second transmission resource is transmitted from a sensing controller node different from the second node to the first node.

The third time position is determined based on a transmission position of resource configuration information of the second transmission resource.

The third time position is determined based on a start position of the transmission position of the resource configuration information of the second transmission resource in a time domain, the third time position is determined based on an end position of the transmission position of the resource configuration information of the second transmission resource in a time domain, or, the third time position is determined based on a start position and an end position of the transmission position of the resource configuration information of the second transmission resource in a time domain, for example, a middle position of the start position and the end position.

Illustratively, the third time position is a time position T duration in advance of the transmission position of the resource configuration information of the second transmission resource. The T duration is predefined, preconfigured, or autonomously determined. The T duration is correlated with a processing delay of the first node in generating sensing result information based on the sensing signal.

In S704, the first node transmits, in response to receiving schedule information within a first duration, part or all of N pieces of first sensing result information over a third transmission resource scheduled by the schedule information, or, the first node transmits, in response to a third transmission resource within a first duration, part or all of N pieces of first sensing result information over the third transmission resource.

A start point of the first duration is a transmission position of the first information or is determined based on a transmission position of the first information. The start point of the first duration is a start position of the transmission position of the first information in a time domain, the start point of the first duration is an end position of the transmission position of the first information in a time domain, the start point of the first duration is a time point K duration in advance of the transmission position of the first information, or, the start point of the first duration is acquired by postponing the K duration. For example, K is a round-trip time (RTT) between the first node and the second node.

A length of the first duration is preconfigured, and the second node and the sensing controller node are dynamically configured, predefined by a communication protocol, or autonomously achieved.

In some embodiments, the schedule information is for scheduling the third transmission resource, and the third transmission resource is for transmitting part or all of the N pieces of first sensing result information.

In some embodiments, the schedule information carries indication of first sensing result information required to be reported. Illustratively, the schedule information carries indication of all of the N pieces of first sensing result information, the schedule information carries indication of the M pieces of first sensing result information, M is a positive integer not greater than N, the schedule information is indicative of M pieces of first sensing result information, or the schedule information instructs to determine M pieces of first sensing result information from the N pieces of first sensing result information. For example, the schedule information carries bitmaps, wherein the bitmap instructs the first node to determine M pieces of first sensing result information from the N pieces of first sensing result information.

For example, the N pieces of first sensing result information are first sensing result information 1 to 4, the M pieces of first sensing result information are first sensing result information 1 and first sensing result information 3 in the case that the bitmap is equal to 1010, and the M pieces of first sensing result information are first sensing result information 3 and first sensing result information 4 in the case that the bitmap is equal to 0011. That is, the bitmap includes N bits, an i^{th} first sensing result information belongs to the M pieces of first sensing result information in the case that a value of the i^{th} bit is a first value (for example, 1), and i^{th} first sensing result information does not belong to the M pieces of first sensing result information in the case that a value of i^{th} bit is a second value (for example, 0).

In some embodiments, M pieces of first sensing result information required to be reported are self-determined by the first node. For example, the first node is determined based on a data amount bearable by the third transmission resource. In some embodiments, the first node is selected from the N pieces of first sensing result information based on a screening condition. The screening condition is for screening out first sensing result information matching an abnormal result.

Illustratively, the first duration T1 is a duration starting from a start position or an end position of the second transmission resource or a start position or an end position of a time unit of the second transmission resource. In the case that the first node receives the schedule information within the first duration T1, or, the transmission position (the start position or the end position) of the third transmission resource indicated by the schedule information is within the first duration T1, the first node transmits the M pieces of first sensing result information over the third transmission resource, and the M pieces of first sensing result information include at least one of the N pieces of first sensing result information.

In some embodiments, in the case that the schedule information is received upon the first duration or the schedule information is not received prior to the end position of the first duration, the first node does not transmit part or all of the N pieces of first sensing result information acquired by the N sets of sensing signals.

In the case that the first node receives the schedule information upon the first duration T1, the first node does not receive the schedule information prior to the end position of the first duration T1, or the transmission position (the start position or the end position) of the third transmission resource indicated by the schedule information is within the first duration T1, the first node clears, releases, and discards part or all of the N pieces of first sensing result information.

In some embodiments, the first node does not expect to receive the schedule information instructing to transmit at least one of the N pieces of first sensing result information outside the first duration T1. Alternatively, the first node does not expect that the transmission resource (the start position or the end position) indicated by the schedule information for transmitting at least one of the N pieces of first sensing result information is outside the first duration T1.

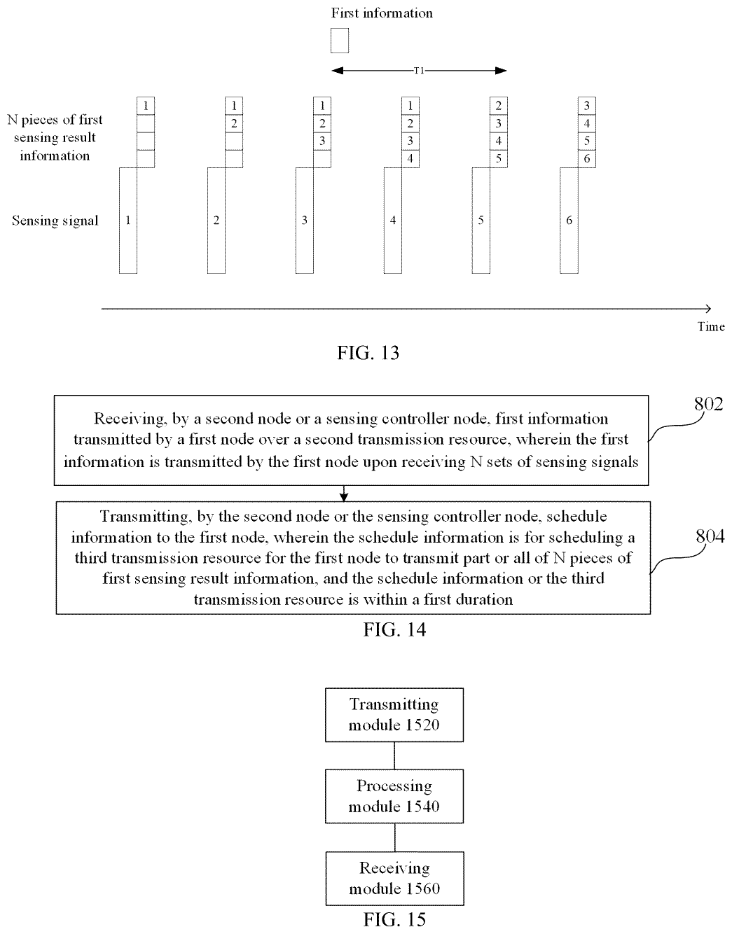

Using FIG. 13 as an example, assuming that N is equal to 2, then the first node detects abnormal sensing upon receiving the sensing signal 3 and transmits the first information. The first node needs to store the first sensing result information 2 and 3 within the first duration T1, and waits the sensing controller node to transmits the schedule information instructing to transmit the first sensing result information 2 and 3. The first node does not need to forcibly store the first sensing result information 2 and 3 in response to expiration of the first duration T1. The earlier first sensing result information 2 and 3 are cleared in response to an updated first sensing result information.

In summary, in the method according to the embodiments, part or all of the N pieces of first sensing result information is reported only in the case that the sensing result is abnormal, such that a resource overhead for reporting the sensing result by the first node to the second node or the sensing controller node is significantly reduced, the system efficiency is improved, and the power consumption of the first node is reduced. In addition, a maximum waiting duration (the first duration) is set for reporting. In the case that the second node or the sensing controller node does not schedule the first node within a waiting first duration, the first node is not invited to store previous sensing result information, such that memory occupation caused by unlimited waiting is avoided, and memory resource overhead of the first node or the hardware cost of the memory is increased.

FIG. 14 is a flowchart of a method for receiving sensing result information according to some embodiments of the present disclosure. The embodiments are illustrated using the method being applicable to a second node or a sensing controller node as an example. The method includes following processes.

In S802, a second node or a sensing controller node receives first information transmitted by a first node over a second transmission resource, wherein the first information is transmitted by the first node upon receiving N sets of sensing signals, and N is a positive integer.

The first node is a node participating in the sensing measurement. In some embodiments, the first node is a sensing signal receiver node. In some embodiments, the first node is a sensing signal transmitter node or a sensing signal receiver node. Roles of the second node in a sensing measurement process are not limited in the embodiments, which are determined according to actual sensing scenarios.

The first node receives N sets of sensing signals, and generates N pieces of first sensing result information based on the N sets of sensing signals. Each set of the N sets of sensing signals includes at least one sensing signal, and numbers of sensing signals in various sets of sensing signals are the same or different. The N pieces of first sensing result information are acquired based on N sets of sensing signals, and N is a positive integer greater than 1. Each set of the N sets of sensing signals includes at least one sensing signal.

In some embodiments, time domain positions of transmitting the N sets of sensing signals are different, or, time domain positions of transmitting at least two sets of sensing signals are different. In some embodiments, the N sets of sensing signals are transmitted periodically or nonperiodically.

In some embodiments, a sensing transmitter node transmits a plurality of sets of sensing signals. The first node acquires N pieces of first sensing result information based on N sets of sensing signals. In some embodiments, N is correlated to a caching capability of the first node. For example, N is equal to or less than a number of pieces of first sensing result information that are cacheable by the first node.

In some embodiments, the first information is indicative of all or part of first sensing result information that the first node expects to report. In some embodiments, the first information is indicative of abnormal first sensing result information. In some embodiments, the first information is for requesting to schedule transmission resources of all or part of the N pieces of first sensing result information.

In some embodiments, the first information includes information indicating at least one of:
an application-oriented sensing result, and the application-oriented sensing result is determined based on the N sets of sensing signals;
resource request information, and the resource request information is for requesting the third transmission resource; or
information acquired based on at least one of the N pieces of first sensing result information.

In some embodiments, the application-oriented sensing result is abnormal sensing result information. For example, the sensing result is applicable to scenarios of falling of a person or object, intrusion of a moving object, counting target objects, and the like.

In some embodiments, the resource request information is for requesting the second node or the sensing controller node to schedule the third transmission resource. The third transmission resource is for the first node to transmit part or all of the N pieces of first sensing result information. The resource request information is a scheduling request (SR).

In some embodiments, the information acquired (screened out) based on at least one of the N pieces of first sensing result information is abnormal sensing result information. Illustratively, the abnormal sensing result information includes sensing result information in the N pieces of first sensing result information that has a value less than a first threshold, sensing result information in the N pieces of first sensing result information that has a value greater than a second threshold, or sensing result information in the N pieces of first sensing result information that has a value change reaching a hopping condition.

The first threshold, the second threshold, and the hopping condition are predefined, preconfigured, dynamically configured, or dynamically determined based on the N pieces of first sensing result information. For example, the first threshold, the second threshold, and the hopping condition are determined based on a mean value and a variance of the N pieces of first sensing result information.

In some embodiments, the first information is further indicative of a value of N or a data amount of the N pieces of first sensing result information.

The second transmission resource is transmission resource occupied by the first information. In some embodiments, the second transmission resource is preconfigured by the second node or the sensing controller node, the second transmission resource is acquired by requesting to the second node or the sensing controller node by the first node through the SR, or, the second transmission resource is acquired by self-selecting from a preconfigured resource pool by the first node. The configuration information of the second transmission resource is not limited in the embodiments.

In some embodiments, the N sets of sensing signals are last N sets of sensing signals prior to a third time position. For example, N is equal to 4, and the N sets of sensing signals are last four sets of sensing signals prior to the third time position. The N pieces of first sensing result information are last four pieces of first sensing result information prior to the third time position. In some embodiments, in a start stage or an ending stage of a plurality of sets of sensing signals, the first sensing result information acquired prior to the third time position by the first node is less than the N pieces of first sensing result information.

### The Third Time Position

In some embodiments, the third time position is in one of following cases.

The third time position is a transmission position (that is, the second transmission resource) of the first information.

The third time position is a start position of the second transmission resource in a time domain, or, the third time position is an end position of the second transmission resource in a time domain.

The third time position is determined based on a time domain position of a transmission position of the first information.

The third time position is determined based on a start position of the second transmission resource in a time domain, the third time position is determined based on an end position of the second transmission resource in a time domain, or, the third time position is determined based on a start position and an end position of the second transmission resource in a time domain, for example, a middle position of the start position and the end position.

Illustratively, the third time position is a time position T duration in advance of the time domain position of the second transmission resource. The T duration is predefined, preconfigured, or autonomously determined. The T duration is correlated with a processing delay of the first node in generating sensing result information based on the sensing signal.

The third time position is a transmission position of resource configuration information of the second transmission resource.

The resource configuration information of the second transmission resource is for configuring the second transmission resource. The resource configuration information of the second transmission resource is transmitted from the second node to the first node, or, the resource configuration information of the second transmission resource is transmitted from a sensing controller node different from the second node to the first node.

The third time position is determined based on a transmission position of resource configuration information of the second transmission resource.

The third time position is determined based on a start position of the transmission position of the resource configuration information of the second transmission resource in a time domain, the third time position is determined based on an end position of the transmission position of the resource configuration information of the second transmission resource in a time domain, or, the third time position is determined based on a start position and an end position of the transmission position of the resource configuration information of the second transmission resource in a time domain, for example, a middle position of the start position and the end position.

Illustratively, the third time position is a time position T duration in advance of the transmission position of the resource configuration information of the second transmission resource. The T duration is predefined, preconfigured, or autonomously determined. The T duration is correlated with a processing delay of the first node in generating sensing result information based on the sensing signal.

In S804, the second node or the sensing controller node transmits schedule information to the first node, wherein the schedule information is for scheduling a third transmission resource for the first node to transmit part or all of N pieces of first sensing result information, and the schedule information or the third transmission resource is within a first duration.

A start point of the first duration is a transmission position of the first information or is determined based on a transmission position of the first information. The start point of the first duration is a start position of the transmission position of the first information in a time domain, the start point of the first duration is an end position of the transmission position of the first information in a time domain, the start point of the first duration is a time point K duration in advance of the transmission position of the first information, or the start point of the first duration is acquired by postponing the K duration. For example, K is an RTT between the first node and the second node.

A length of the first duration is preconfigured, and the second node and the sensing controller node are dynamically configured, predefined by a communication protocol, or autonomously achieved.

In some embodiments, the schedule information is for scheduling the third transmission resource, and the third transmission resource is for transmitting part or all of the N pieces of first sensing result information.

In some embodiments, the schedule information carries indication of first sensing result information required to be reported. Illustratively, the schedule information carries indication of all of the N pieces of first sensing result information, the schedule information carries indication of the M pieces of first sensing result information, M is a positive integer not greater than N, the schedule information is indicative of M pieces of first sensing result information, or the schedule information instructs to determine M pieces of first sensing result information from the N pieces of first sensing result information. For example, the schedule information carries bitmaps, and the bitmap instructs the first node to determine M pieces of first sensing result information from the N pieces of first sensing result information.

For example, the N pieces of first sensing result information are first sensing result information 1 to 4, the M pieces of first sensing result information are first sensing result information 1 and first sensing result information 3 in the case that the bitmap is equal to 1010, and the M pieces of first sensing result information are first sensing result information 3 and first sensing result information 4 in the case that the bitmap is equal to 0011. That is, the bitmap includes N bits, i^{th} first sensing result information belongs to the M pieces of first sensing result information in the case that a value of an i^{th} bit is a first value (for example, 1), and i^{th} first sensing result information does not belong to the M pieces of first sensing result information in the case that a value of the i^{th} bit is a second value (for example, 0).

In some embodiments, M pieces of first sensing result information required to be reported are self-determined by the first node. For example, the first node is determined based on a data amount bearable by the third transmission resource. In some embodiments, the first node is selected from the N pieces of first sensing result information based on a screening condition. The screening condition is for screening out first sensing result information matching an abnormal result.

Illustratively, the first duration T1 is a duration starting from a start position or an end position of the second transmission resource or a start position or an end position of a time unit of the second transmission resource. In the case that the first node receives the schedule information within the first duration T1, or the transmission position (the start position or the end position) of the third transmission resource indicated by the schedule information is within the first duration T1, the first node transmits the M pieces of first sensing result information over the third transmission resource, and the M pieces of first sensing result information include at least one of the N pieces of first sensing result information.

In the case that the schedule information is received upon the first duration or the schedule information is not received prior to the end position of the first duration, the first node does not transmit part or all of the N pieces of first sensing result information acquired by the N sets of sensing signals.

In the case that the first node receives the schedule information upon the first duration T1, the first node does not receive the schedule information prior to the end position of the first duration T1, or the transmission position (the start position or the end position) of the third transmission resource indicated by the schedule information is within the first duration T1, the first node clears, releases, and discards part or all of the N pieces of first sensing result information.

In some embodiments, the first node does not expect to receive the schedule information instructing to transmit at least one of the N pieces of first sensing result information outside the first duration T1. Alternatively, the first node does not expect that the transmission resource (the start position or the end position) indicated by the schedule information for transmitting at least one of the N pieces of first sensing result information is outside the first duration T1.

The second node or the sensing controller node receives part or all of the N pieces of first sensing result information transmitted by the first node over the third transmission resource.

In summary, in the method according to the embodiments, part or all of the N pieces of first sensing result information is reported only in the case that the sensing result is abnormal, such that a resource overhead for reporting the sensing result by the first node to the second node or the sensing controller node is significantly reduced, the system efficiency is improved, and the power consumption of the first node is reduced. In addition, a maximum waiting duration (the first duration) is set for reporting. In the case that the second node or the sensing controller node does not schedule the first node within a waiting first duration, the first node is not invited to store previous sensing result information, such that memory occupation caused by unlimited waiting is avoided, and memory resource overhead of the first node or the hardware cost of the memory is increased.

FIG. 15 is a block diagram of an apparatus for transmitting sensing result information according to some embodiments of the present disclosure. The apparatus includes: a transmitting module 1520, a processing module 1540, and a receiving module 1560.

The transmitting module 1520 is configured to transmit M pieces of first sensing result information over a first transmission resource;
wherein the M pieces of first sensing result information are acquired based on M sets of sensing signals, and M is a positive integer greater than 1, wherein each set of the M sets of sensing signals includes at least one sensing signal.

In some embodiments, the M sets of sensing signals are last M sets of sensing signals prior to a first time position; wherein
the first time position is a time domain position of the first transmission resource;
the first time position is determined based on a time domain position of the first transmission resource;
the first time position is a transmission position of indication information; or
the first time position is determined based on a transmission position of indication information;
wherein indication information instructs the first node to transmit the M pieces of first sensing result information.

In some embodiments, the processing module 1540 is configured to acquire N pieces of first sensing result information based on N sets of sensing signals, wherein N is greater than or equal to M, and the N pieces of first sensing result information include the M pieces of first sensing result information.

In some embodiments, the N sets of sensing signals are last N sets of sensing signals prior to a second time position; wherein
the second time position is a time domain position of the first transmission resource;
the second time position is a transmission position of indication information;
the second time position is determined based on a time domain position of the first transmission resource; or
the second time position is determined based on a transmission position of indication information;
wherein indication information instructs the first node to transmit the M pieces of first sensing result information.

In some embodiments, a value of M is indicated by the indication information, and/or information for determining the M pieces of first sensing result information from the N pieces of first sensing result information is indicated by the indication information.

In some embodiments, the receiving module 1560 is configured to receive configuration information, wherein the configuration information is indicative of information indicating at least one of:
the first transmission resource; or
a value of M.

In some embodiments, the M pieces of first sensing result information include information indicating at least one of:
characteristic parameters of the M sets of sensing signals;
offset information or difference information of characteristic parameters of the M sets of sensing signals;
channel information experienced by the M sets of sensing signals;
offset information or difference information of channel information experienced by the M sets of sensing signals; or
an application-oriented sensing result.

It should be noted that the apparatus in the embodiments is configured to perform corresponding processes performed by the first node in the above embodiments. For details not given in the embodiments, reference may be made to the method embodiments, which are not repeated herein.

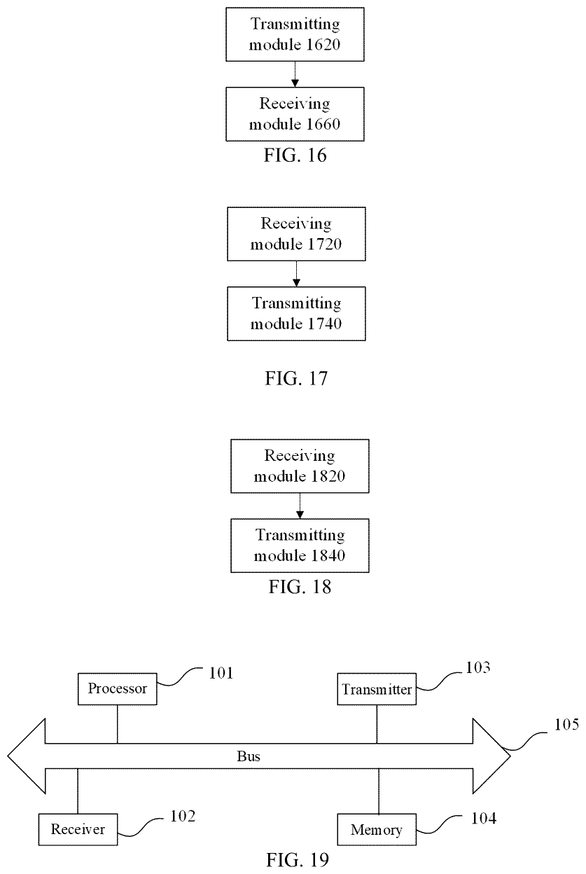

FIG. 16 is a block diagram of an apparatus for transmitting sensing result information according to some embodiments of the present disclosure. The apparatus includes: a transmitting module 1620 and a receiving module 1660.

The transmitting module 1620 is configured to transmit first information over a second transmission resource upon receiving N sets of sensing signals, wherein N is a positive integer; and
the transmitting module 1620 is configured to transmit, in response to receiving schedule information within a first duration, part or all of N pieces of first sensing result information over a third transmission resource scheduled by the schedule information; or, transmitting, by the first node in response to a third transmission resource within a first duration, part or all of N pieces of first sensing result information over the third transmission resource;
wherein a start point of the first duration is a transmission position of the first information or is determined based on a transmission position of the first information, the N pieces of first sensing result information are acquired based on the N sets of sensing signals, and each set of the N sets of sensing signals includes at least one sensing signal.

In some embodiments, the first information includes information indicating at least one of:
an application-oriented sensing result, wherein the application-oriented sensing result is determined based on the N sets of sensing signals;
resource request information, wherein the resource request information is for requesting the third transmission resource; or
information acquired based on at least one of the N pieces of first sensing result information.

In some embodiments, information acquired based on at least one of the N pieces of first sensing result information includes:
sensing result information in the N pieces of first sensing result information that has a value less than a first threshold;
sensing result information in the N pieces of first sensing result information that has a value greater than a second threshold; or
sensing result information in the N pieces of first sensing result information that has a value change reaching a hopping condition.

In some embodiments, the first information is indicative of a value of N.

In some embodiments, the transmitting module 1620 is further configured to not transmit part or all of the N pieces of first sensing result information in response to receiving the schedule information upon the first duration;
the transmitting module 1620 is further configured to not transmit part or all of the N pieces of first sensing result information in response to not receiving the schedule information prior to expiration of the first duration; or
the transmitting module 1620 is further configured to not transmit part or all of the N pieces of first sensing result information in response to the third transmission resource upon the first duration.

In some embodiments, the N pieces of first sensing result information include information indicating at least one of:
characteristic parameters of the N sets of sensing signals;
offset information or difference information of characteristic parameters of the N sets of sensing signals;
channel information experienced by the N sets of sensing signals; or
offset information or difference information of channel information experienced by the N sets of sensing signals.

It should be noted that the apparatus in the embodiments is used to perform corresponding processes performed by the first node in the above embodiments. For details not detailed in the embodiments, reference may be made to the above method embodiments, which are not repeated herein.

FIG. 17 is a block diagram of an apparatus for receiving sensing result information according to some embodiments of the present disclosure. The apparatus includes a receiving module 1720 and a transmitting module 1740.

The receiving module 1720 is configured to receive M pieces of first sensing result information from a first node;
wherein the M pieces of first sensing result information are transmitted by the first node over a first transmission resource and are acquired based on M sets of sensing signals, and M is a positive integer greater than 1, wherein each set of the M sets of sensing signals includes at least one sensing signal.

In some embodiments, the M sets of sensing signals are last M sets of sensing signals prior to a first time position; wherein
the first time position is a time domain position of the first transmission resource;
the first time position is determined based on a time domain position of the first transmission resource;
the first time position is a transmission position of indication information; or
the first time position is determined based on a transmission position of indication information;
wherein indication information instructs the first node to transmit the M pieces of first sensing result information.

In some embodiments, the transmitting module 1740 is configured to transmit N sets of sensing signals, wherein N is greater than or equal to M, and the N sets of sensing signals include the M sets of sensing signals.

In some embodiments, the N sets of sensing signals are last N sets of sensing signals prior to a second time position; wherein
the second time position is a time domain position of the first transmission resource;
the second time position is a transmission position of indication information;
the second time position is determined based on a time domain position of the first transmission resource; or
the second time position is determined based on a transmission position of indication information;
wherein the indication information instructs the first node to transmit the M pieces of first sensing result information.

In some embodiments, the transmitting module 1740 is configured to transmit indication information, wherein the indication information is indicative of a value of M, and/or the indication information further instructs to determine the M pieces of first sensing result information from N pieces of first sensing result information.

In some embodiments, the transmitting module 1740 is configured to transmit configuration information, wherein the configuration information is indicative of information indicating at least one of: the first transmission resource, or a value of M.

In some embodiments, the M pieces of first sensing result information include information indicating at least one of:
characteristic parameters of the M sets of sensing signals;
offset information or difference information of characteristic parameters of the M sets of sensing signals;
channel information experienced by the M sets of sensing signals;
offset information or difference information of channel information experienced by the M sets of sensing signals; or
an application-oriented sensing result.

FIG. 18 is a block diagram of an apparatus for receiving sensing result information according to some embodiments of the present disclosure. The apparatus includes a receiving module 1820 and a transmitting module 1840.

The receiving module 1820 is configured to receive first information from a first node, wherein the first information is transmitted by the first node over a second transmission resource upon receipt of N sets of sensing signals, and N is a positive integer; and
the transmitting module 1840 is configured to transmit schedule information to the first node, wherein the schedule information is for scheduling a third transmission resource for the first node to transmit part or all of N pieces of first sensing result information, and the schedule information and/or the third transmission resource is within a first duration,
wherein a start point of the first duration is a transmission position of the first information or is determined based on a transmission position of the first information, the N pieces of first sensing result information are acquired based on the N sets of sensing signals, and each set of the N sets of sensing signals includes at least one sensing signal.

In some embodiments, the first information includes:
an application-oriented sensing result, wherein the application-oriented sensing result is determined based on the N sets of sensing signals;
resource request information, wherein the resource request information is for requesting the third transmission resource; or
information acquired based on at least one of the N pieces of first sensing result information.

In some embodiments, the information acquired based on at least one of the N pieces of first sensing result information includes:
sensing result information in the N pieces of first sensing result information that has a value less than a first threshold;
sensing result information in the N pieces of first sensing result information that has a value greater than a second threshold; or
sensing result information in the N pieces of first sensing result information that has a value change reaching a hopping condition.

In some embodiments, the first information is indicative of a value of N.

In some embodiments, the N pieces of first sensing result information include information indicating at least one of:
characteristic parameters of the N sets of sensing signals;
offset information or difference information of characteristic parameters of the N sets of sensing signals;
channel information experienced by the N sets of sensing signals; or
offset information or difference information of channel information experienced by the N sets of sensing signals.

FIG. 19 is a schematic block diagram of a sensing measurement device (a first node, a second node, a sensing transmitter node, a sensing receiver node, or a sensing controller node) according to some embodiments of the present disclosure. The communication device includes: a processor 101, a receiver 102, a transmitter 103, a memory 104, and a bus 105.

The processor 101 includes one or more processing cores, and achieves various functional applications and information processing by running software programs and modules.

The receiver 102 and the transmitter 103 are practiced as a communication assembly, and the communication assembly is a communication chip. The communication assembly is also referred to as a transceiver.

The memory 104 is connected to the processor 101 over a bus 105.

The memory 104 is configured to store one or more instructions, and the processor 101, when loading and executing the one or more instructions, is caused to perform various processes in the above method embodiments.

In addition, the memory 104 is achieved by any type of volatile or non-volatile storage device or combinations thereof. The volatile or non-volatile storage device includes, but is not limited to, a disk or optical disc, an electrically-erasable programmable read only memory (EEPROM), an erasable programmable read-only memory (EPROM), a static random access memory (SRAM), a read-only memory (ROM), a magnetic memory, a flash memory, or a programmable read-only memory (PROM).

The processor and the transceiver in the sensing measurement device in the embodiments of the present disclosure perform processes performed by the first node, the second node, the sensing transmitter node, the sensing receiver node, or the sensing controller node in the above method embodiments, which are not described again herein.

Some embodiments of the present disclosure further provide a computer-readable storage medium storing at least one instruction, at least one program, a code set, or an instruction set. The at least one instruction, the at least one program, the code set, or the instruction set, when loaded and executed by a processor, causes the processor to perform the method for transmitting sensing result information or the method for receiving sensing result information applicable to the communication device in the above method embodiments.

Some embodiments of the present disclosure further provide a chip including a programable logical circuity and/or program instructions. The chip, when running on a computer device, is caused to perform the method for transmitting sensing result information or the method for receiving sensing result information applicable to the communication device in the above method embodiments.

Some embodiments of the present disclosure further provide a computer program product. The computer program product, when running on a processor of a computer device, causes the computer device to perform the method for transmitting sensing result information or the method for receiving sensing result information applicable to the communication device in the above method embodiments.

It is understandable by those of ordinary skill in the art that all or part of processes in the above embodiments are performed by hardware or by a program instructing the relevant hardware, the programs are stored in a computer-readable storage medium, and the above storage medium is a ROM, a disk, optical disc, and the like.

Described above are merely exemplary embodiments of the present disclosure, and are not intended to limit the present disclosure. Any modifications, equivalent replacements, improvements and the like made within the spirit and principles of the present disclosure should be encompassed within the scope of protection of the present disclosure.

1. A method for transmitting sensing result information, applicable to a first node, the method comprising:
transmitting M pieces of first sensing result information over a first transmission resource, wherein the M pieces of first sensing result information are acquired based on M sets of sensing signals, and M is a positive integer greater than 1, wherein each set of the M sets of sensing signals comprises at least one sensing signal.

2. The method according to claim 1, wherein the M sets of sensing signals are last M sets of sensing signals prior to a first time position; wherein the first time position is a time domain position of the first transmission resource, the first time position is determined based on a time domain position of the first transmission resource, the first time position is a transmission position of indication information, or, the first time position is determined based on a transmission position of indication information;
wherein indication information instructs the first node to transmit the M pieces of first sensing result information.

3. The method according to claim 1, further comprising:
acquiring N pieces of first sensing result information based on N sets of sensing signals, wherein N is greater than or equal to M, and the N pieces of first sensing result information comprise the M pieces of first sensing result information.

4. The method according to claim 3, wherein the N sets of sensing signals are last N sets of sensing signals prior to a second time position; wherein the second time position is a time domain position of the first transmission resource, the second time position is a transmission position of indication information, the second time position is determined based on a time domain position of the first transmission resource, or, the second time position is determined based on a transmission position of indication information;
wherein indication information instructs the first node to transmit the M pieces of first sensing result information.

5. The method according to claim 4, wherein a value of M is indicated by the indication information.

6. The method according to claim 4, wherein information for determining the M pieces of first sensing result information from the N pieces of first sensing result information is indicated by the indication information.

7. The method according to claim 1, further comprising:
receiving configuration information, wherein the configuration information is indicative of information indicating at least one of: the first transmission resource, or a value of M.

8. The method according to claim 1, wherein the M pieces of first sensing result information comprise information indicating at least one of: characteristic parameters of the M sets of sensing signals, offset information or difference information of characteristic parameters of the M sets of sensing signals, channel information experienced by the M sets of sensing signals, offset information or difference information of channel information experienced by the M sets of sensing signals, or an application-oriented sensing result.

9. A method for transmitting sensing result information, applicable to a first node, the method comprising:
transmitting first information over a second transmission resource upon receiving N sets of sensing signals, wherein N is a positive integer; and
transmitting, in response to receiving schedule information within a first duration, part or all of N pieces of first sensing result information over a third transmission resource scheduled by the schedule information; or, transmitting, in response to a third transmission resource within a first duration, part or all of N pieces of first sensing result information over the third transmission resource, wherein a start point of the first duration is a transmission position of the first information or is determined based on a transmission position of the first information, the N pieces of first sensing result information are acquired based on the N sets of sensing signals, and each set of the N sets of sensing signals comprises at least one sensing signal.

10. The method according to claim 9, wherein the first information comprises information indicating at least one of:
an application-oriented sensing result, wherein the application-oriented sensing result is determined based on the N sets of sensing signals;
resource request information, wherein the resource request information is for requesting the third transmission resource; or
information acquired based on at least one of the N pieces of first sensing result information.

11. The method according to claim 10, wherein the information acquired based on at least one of the N pieces of first sensing result information comprises:
sensing result information in the N pieces of first sensing result information that has a value less than a first threshold;
sensing result information in the N pieces of first sensing result information that has a value greater than a second threshold; or
sensing result information in the N pieces of first sensing result information that has a value change reaching a hopping condition.

12. The method according to claim 9, wherein the first information is indicative of a value of N.

13. The method according to claim 9, further comprising:
not transmitting part or all of the N pieces of first sensing result information in response to receiving the schedule information upon the first duration;
not transmitting part or all of the N pieces of first sensing result information in response to not receiving the schedule information prior to expiration of the first duration; or
not transmitting part or all of the N pieces of first sensing result information in response to the third transmission resource upon the first duration.

14. The method according to claim 9, wherein the N pieces of first sensing result information comprise information indicating at least one of: characteristic parameters of the N sets of sensing signals, offset information or difference information of characteristic parameters of the N sets of sensing signals, channel information experienced by the N sets of sensing signals, or offset information or difference information of channel information experienced by the N sets of sensing signals.

15. A sensing measurement device, comprising:
a processor and a memory storing at least one program, which when executed by the processor, cause the sensing measurement device to:
transmit M pieces of first sensing result information over a first transmission resource, wherein the M pieces of first sensing result information are acquired based on M sets of sensing signals, and M is a positive integer greater than 1, wherein each set of the M sets of sensing signals comprises at least one sensing signal.

16. The sensing measurement device according to claim 15, wherein the M sets of sensing signals are last M sets of sensing signals prior to a first time position; wherein the first time position is a time domain position of the first transmission resource, the first time position is determined based on a time domain position of the first transmission resource, the first time position is a transmission position of indication information, or, the first time position is determined based on a transmission position of indication information;
wherein indication information instructs a first node to transmit the M pieces of first sensing result information.

17. The sensing measurement device according to claim 15, wherein the at least one program, which when executed by the processor, further cause the sensing measurement device to:
acquire N pieces of first sensing result information based on N sets of sensing signals, wherein N is greater than or equal to M, and the N pieces of first sensing result information comprise the M pieces of first sensing result information.

18. The sensing measurement device according to claim 17, wherein the N sets of sensing signals are last N sets of sensing signals prior to a second time position; wherein the second time position is a time domain position of the first transmission resource, the second time position is a transmission position of indication information, the second time position is determined based on a time domain position of the first transmission resource, or, the second time position is determined based on a transmission position of indication information;
wherein indication information instructs a first node to transmit the M pieces of first sensing result information.

19. The sensing measurement device according to claim 15, wherein the at least one program, which when executed by the processor, cause the sensing measurement device to:
receive configuration information, wherein the configuration information is indicative of information indicating at least one of: the first transmission resource, or a value of M.

20. The sensing measurement device according to claim 15, wherein the M pieces of first sensing result information comprise information indicating at least one of: characteristic parameters of the M sets of sensing signals, offset information or difference information of characteristic parameters of the M sets of sensing signals, channel information experienced by the M sets of sensing signals, offset information or difference information of channel information experienced by the M sets of sensing signals, or an application-oriented sensing result.
